(19) United States
(12) Patent Application Publication
(10) Pub. No.: US 2013/0061174 A1
(43) Pub. Date: Mar. 7, 2013

(54) METHOD AND SYSTEM FOR DYNAMICALLY PROVIDING PRODUCT CONFIGURATIONS

(71) Applicants: Thomas James Buchanan, Gernika-Lumo (ES); Andrew Charles Gilbert, Devon (GB)

(72) Inventors: Thomas James Buchanan, Gernika-Lumo (ES); Andrew Charles Gilbert, Devon (GB)

(73) Assignee: SIEMENS PRODUCT LIFECYCLE MANAGEMENT SOFTWARE INC., Plano, TX (US)

(21) Appl. No.: 13/600,922

(22) Filed: Aug. 31, 2012

Related U.S. Application Data
(60) Provisional application No. 61/530,291, filed on Sep. 1, 2011.

(51) Int. Cl. G06F 3/048

(52) U.S. Cl. 715/810

(57) ABSTRACT

Product data management systems and methods. A method includes determining a user identification and identifying a plurality of product contexts corresponding to the user identification and based on a user role, including performing a query on a database. The method includes displaying configuration items corresponding to the identified contexts and receiving a user selection of a configuration item. The method includes launching a tool based on the selected confirmation item, including loading configuration data according to the selected configuration item and corresponding identified context.

### CROSS-REFERENCE TO RELATED APPLICATION

The application claims the benefit of the filing date of U.S. Provisional Patent Application 61/530,291, filed Sep. 1, 2011, which is hereby incorporated by reference.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or “PDM” systems).

### BACKGROUND OF THE DISCLOSURE

When a user in an engineering organization, for example, is ready to retrieve and work with his assigned projects, it would be helpful for the user to be able to quickly access the relevant data.

### SUMMARY OF THE DISCLOSURE

This disclosure includes product data management systems and methods. A method includes determining a user identification and identifying a plurality of product contexts corresponding to the user identification and based on a user role, including performing a query on a configuration database. The method includes displaying configuration items corresponding to the identified contexts and receiving a user selection of a configuration item. The method includes launching a tool based on the selected confirmation item, including loading configuration data according to the selected configuration item and corresponding identified context.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments. Other technical features may be readily apparent to one skilled in the art from the following figures, descriptions, and claims.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a high-level diagram of components of a PDM system in accordance with disclosed embodiments;

FIG. 3 illustrates an example of a portion of a user interface provided by a PDM interface application in accordance with disclosed embodiments; and

FIG. 4 depicts a flowchart of a process in accordance with disclosed embodiments.

### DETAILED DESCRIPTION

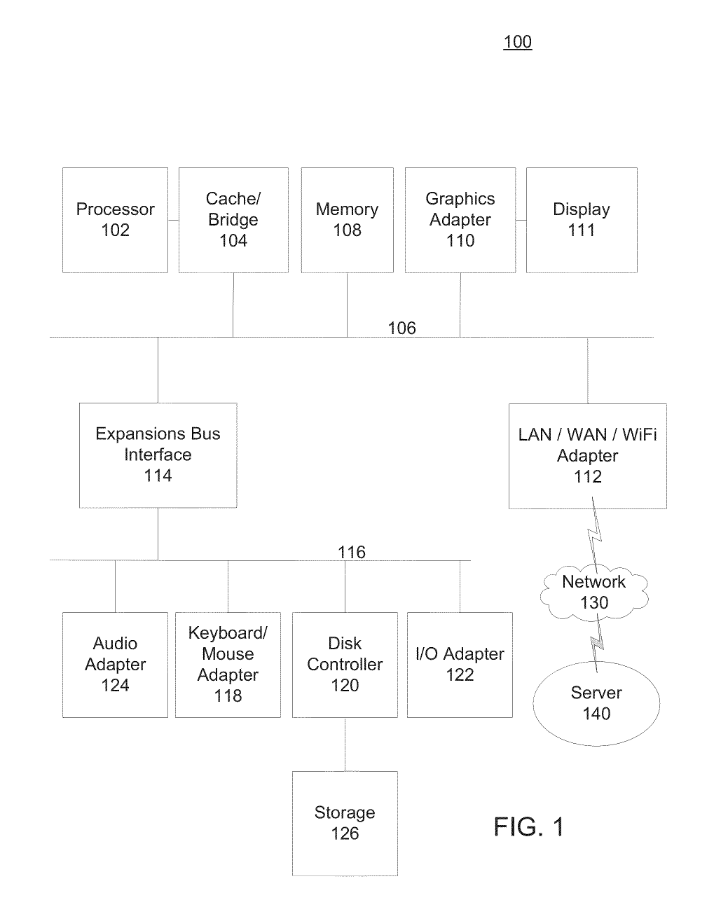

FIGS. 1 through 4, and the various embodiments used to describe the disclosed systems and methods are by way of illustration only and should not be construed in any way to limit the scope of the disclosure. Those skilled in the art will understand that the principles of the invention may be implemented in any type of suitably arranged device or system.

Disclosed embodiments include systems and methods for creating, running, and returning a query that lists available configurations of a product that are relevant to a specific user. In addition, various embodiments provide a highly visual means of presenting this information to the user in such a way that they can access any configuration found in a quick and simple manner, for example with a single click or drag and drop gesture of the mouse.

FIG. 1 depicts a block diagram of a data processing system 100 in which an embodiment can be implemented, for example as a PDM system particularly configured by software or otherwise to perform the processes as described herein, and in particular as each one of a plurality of interconnected and communicating systems as described herein. The data processing system 100 depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments include systems and methods that can automatically gather a list of product configurations on demand and present them to the user in such a way that the configurations are easily accessible whenever the user desires them. Disclosed embodiments also provide a means of managing sets of configurations for convenience and ease of use. Other aspects of some embodiments allow a user to easily navigate between higher-level and lower-level assemblies in the product configuration.

Disclosed embodiments also include systems and methods that provide a user in an engineering organization with a means to quickly access pre-determined contexts of a product or platform that are meaningful to them. Whether a particular product or platform context is meaningful to a user can either be determined explicitly by the user themselves (subscription), by another user (projection), or by heuristics as described herein. The heuristics that determine which contexts are “meaningful” are based on characteristics of the contexts such as project membership, access privileges, previous access, etc.

The “context,” as used herein, can include one or more of the following characteristics, and some uses and properties are described in more detail below:

Configuration (effectivity, product options, revision rule);

Search that retrieves or includes only some objects from a configuration;

Navigation that allows the user to drill down into an area of interest; and

A visual report whose groups output can be used to refine a context.

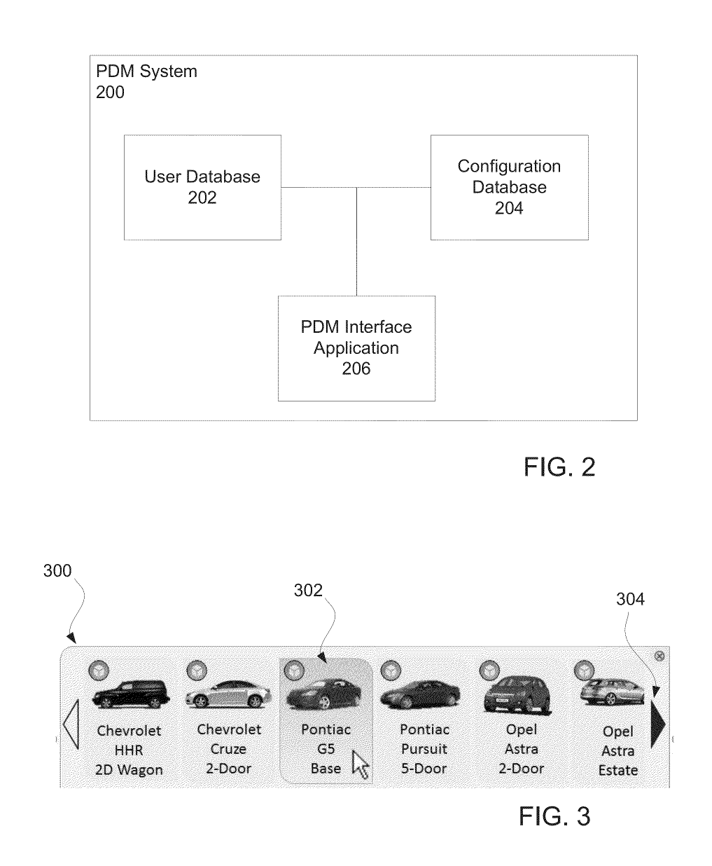

FIG. 2 depicts a high-level diagram of components of a PDM system 200 in accordance with disclosed embodiments. PDM system 200 can be implemented, for example, by one or more data processing systems 100, and in particular can be implemented in a client-server model where some components and processes are implemented on different physical systems than other components and processes.

In this figure, PDM system 200 includes a user database 202. User database 202 can include such information as user credentials and roles, and can maintain information related to activity of the user using the PDM interface application 206.

The system can interact with a user to define a context. As the system interacts with the user, the user is able to capture a context that is meaningful to them by searching for objects in a pre-determined configuration. The user then opens a particular configuration in its entirety (by opening the top level) or by opening a sub-assembly. The user is able to navigate to a particular level in the product context that is of interest to them. The user is able to further refine this context by searching within it. Objects that do not match the search criteria are excluded from the context. The user is also able to apply a visual report to this context. The visual report colors the parts in the scene according to a particular property of interest. The visual report groups objects in the context that have the same or similar values for the property that is being reported on. The user is able to further refine the context by hiding and showing these groups.

The system can also save a context associated with a user. The user is able to save a context, in some embodiments, by hitting a “Send to Shelf” button, though other embodiments can use other labels and mechanisms. This puts the context into a particular tab within a shelf of the tiles described herein. The tabs on the shelf can be pre-defined for the user, and the user is able to create their own tabs to organize shelf objects. The complete state of how the context was defined is remembered by the shelf object, tile, or other configuration item. In some embodiments, it is possible for a user to put objects onto another user's shelf.

A “configuration item,” as used herein, refers to a tile, icon, or other selectable object in the user interface that represents a specific context. The system can retrieve a configuration based on the context as represented by a configuration item on the user interface or shelf. The user navigates the contexts presented in the shelf tabs. Each tab presents a visual list of the contexts it contains, represented as configuration items. The user simply selects the context they would like to load and it is launched into a tool such as a visualization tool. Configuration, navigation level, context search, and visual reports are all stored and the correct context is loaded into the tool. If the pre-defined configuration upon which the context is based has changed since the context was saved to the shelf, these changes will be reflected in what is loaded into the tool.

PDM system 200 also includes a configuration database 204. Configuration database 204 stores multiple product configurations, including options and variants for the configurations, for designed or manufactured products. The product configurations can include data for creating and displaying three-dimensional (3D) representations of the assemblies, subassemblies, and individual components of the products. The product configurations can be stored as unconfigured data that can be configured on the fly according to queries sent by the PDM interface application 206. In particular embodiments, the product configurations include bill of material (BOM) list data for the configured or unconfigured products.

PDM interface application 206 represents a PDM application configured to perform as described herein by interacting with the user, the user database 202, and the configuration database 204. In particular, PDM interface application 206 can authenticate user credentials, identify user roles, and track user activity within the PDM application in conjunction with user database 202. Further, and as described in more detail below, PDM interface application 206 can query the configuration database 204, configure data from configuration database 204, and display 3D representations and other data to a user based on the configuration database 204. In some implementations, PDM interface application 206 can be a “client-side” application on a data processing system with which the user is directly interacting. In other implementations, PDM interface application can be a “server-side” application on a data processing system that performs processes as described herein, but interacts with a user on a different physical data processing system, causing the second data processing system to display results and configuration items as described herein.

PDM interface application 206 enables a user to quickly access configurations of a product that they will find useful. In some embodiments, this list of product configurations is presented as configuration items such as “tiles” within the PDM interface application 206.

Once a set of meaningful contexts has been derived using any of the above techniques, they are presented to the user by the PDM interface application, such in a visual list of configuration items that allows the user to very quickly launch the context into an appropriate tool. The visual lists of configuration items are themselves organized into categories that are meaningful to the user. Each time the user accesses the list its content can be different, as the methods described above may be pushing different content to the user, as described in more detail below. That is, the configuration items visible to the user may change depending on the contexts or other considerations described herein, to reflect the user's current use.

FIG. 3 illustrates an example of a portion of a user interface 300 provided by PDM interface application 206. In this example, a horizontal series of tiles represents available configuration items, which represent specific contexts of product configurations, and can be filtered as described herein. In this example, the product configurations are different models of automobiles. Tile 302 indicates that it represents the configuration of a “Pontiac G5 Base” model vehicle.

Each tile can present various information about each product configuration and context. In this example, tile 302 shows a “thumbnail” of the vehicle. Such thumbnails can be a 2D image or 3D preview. Tile 302 also shows the identification “Pontiac G5 Base” of the configuration represented by the tile. In this example, the tiles are arranged horizontally on a “shelf”, which can be used to group related tiles or configurations.

Where there are more tiles or configuration items than are displayed at a given time, the system can allow the user to scroll to other product configurations. In the example of FIG. 3, the user can select an arrow 304 to “rotate” the visible configurations items in a carousel fashion to display other selectable configurations. Similarly, the system can present selectable tabs that switch the view to a new “shelf” of tiles.

These tiles provide quick access to tools that can be used to view, edit, or report on the content of the product configuration. For example, the user is able to drag and drop a tile into an active tool (such as a CAD editor or visualization tool) to start working with the corresponding configuration. In other cases, the user can “double-click” a tile to launch the product configuration into its default tool.

A list of product configurations such as that in user interface portion 300 is generated by running a query by the PDM interface application 206 of available product configurations in configuration database 204. This query returns those product configurations that are deemed of interest to the user, for example based on the user credentials, role, or other data maintained in user database 202.

By automatically forming queries based on factors such as the user credentials, role, or activity, the system can automatically determine which users will find which product configurations of interest, based on pre-existing knowledge about the users' role and current project assignments. The queries can also be customized to use more specific criteria of the configurations, such as creation date, owning user, etc.

Disclosed embodiments can perform a configuration “on the fly” to automatically gather a list of product configurations on demand and present them to the user via PDM interface application 206. This allows the configurations to be easily accessible whenever the user requires them. PDM interface application 206 can also enable the user to manage sets of configurations for convenience and ease of use, for example by grouping tiles (or other configuration representations) in separate “tabs” or lists according to criteria such as type of configuration, age of configuration, or others, including simply the user's preferred grouping.

PDM interface application 206 can form and run a query against available product configurations in configuration database 204, and then pre-filter or post-filter the results to return only those results that meet a given criteria or relevance to the user. This process can be run against live data on demand and as such provides the user with effectively real-time results.

As described herein, the filtering can be based on a user search, navigation, or a visual report, or some combination of these. The user can search through a given configuration to return only those objects that include certain key words or specific characteristics. The user can also manually navigate through the structure to specify which level they are interested in. The user can use the groups of a visual report to specify which objects are included or excluded from the context. The user can also manually exclude objects from the context that are not important to them.

PDM interface application 206 can present the results of the query as a visual representation of each configuration or context together with an optional description, such as in tile 302. The display is in the form of a list of configuration items such as tiles or thumbnails that the user can scroll through easily and which allows a context to be launched into a visualization tool or other tool by a drag and drop gesture or other keyboard/mouse input.

Once the user has selected a configuration item, the PDM interface application can perform visualization functions to display a product configuration according to the selected configuration item. In particular, the PDM interface application can show a first view of a first assembly of the configuration, and then can further customize the view by interacting with the user, saving the customization for potential use as a context for future selection. The “first” view in this case is an arbitrary view used to describe the different visualizations possible in accordance with disclosed embodiments, and the “first” assembly is an arbitrary assembly in the product configuration. Preferably, the selected configuration item and the context it represents define the first view.

Based on a user input such as a selection of a subassembly of the first assembly, the system can “zoom in” or “expand” the view of that subassembly and its components and replace the first view with a detailed view of the subassembly and its components.

Based on a different user input, such as a “zoom out” selection, the system can zoom out to a higher-level view to show the super-assembly in which first is present. This can include hiding details of the lower-level, detailed view in favor of showing the relative locations of the various assemblies in the product.

Any of the various visualizations can include 3D modeling of the configured product, assemblies, or components, including an “exploded” view of any of these. In alternate embodiments, they can include showing a tree structure, BOM structure, or other PDM-related structure of the product.

In various embodiments, each of the views can be configured on the fly based on which portions of the product are to be shown. For example, in a higher-level view where many of the assemblies are hidden, the system need only query the configuration database to retrieve and display the configured portions in view. Similarly, when only a specific assembly is shown, the system need only query the configuration database to retrieve and display the components of that assembly.

Using such interactions, the system enables the user to move between higher-level and lower-level views of the configuration, performing on-the-fly configuration, querying, and visualization functions. The system can save or update context based on the user visualization and navigation, so that the user can quickly return to his preferred view, in the correct context, simply by selecting a configuration item. As the user navigates or edits the configuration, the system can create a context according to a user's selected configuration, navigation level, context search, and visual reports, or other information, and store the created context as associated with a configuration item.

The various embodiments described herein allow users to quickly define contexts using search, navigation, and visual reporting. This can be combined with processes to allow the user to quickly browse and retrieve only those contexts that are relevant to them. Together, these capabilities help to make the entire definition-save-retrieval loop a compelling user experience.

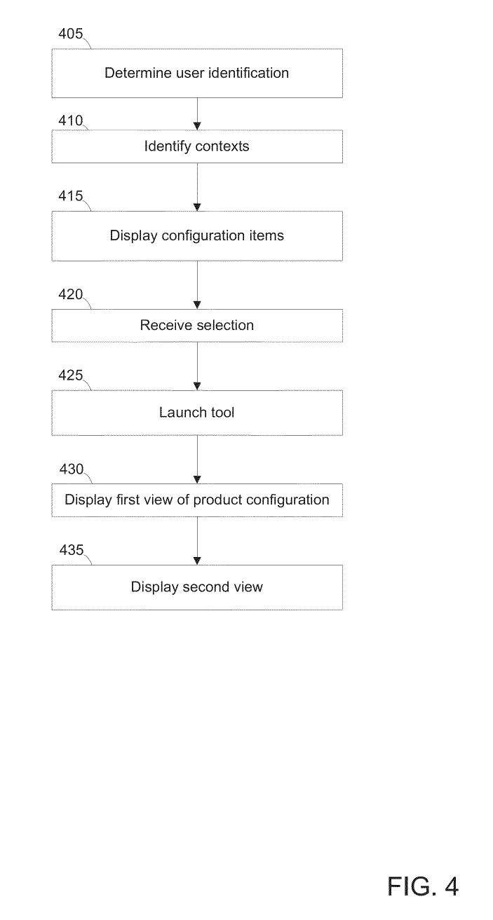

FIG. 4 depicts a flowchart of a process in accordance with disclosed embodiments. This process can be performed by one or more data processing systems, including by a system such as PDM system 200, referred to generically as the “system” below.

The system interacts with a user to determine a user identification (step 405). This can be, for example, a username. This step can include verifying the user identification using user credentials stored in a user database. Interacting with the user can be performed by a PDM interface application as described herein.

The system identifies a plurality of contexts corresponding to the user identification (step 410). This can include identifying the contexts based on product configurations, the role corresponding to the user identification, such as a role stored in the user database or the context of the user as maintained by the user database or a PDM interface application. The configurations can represent products, and each context can be defined based on one or more of a user search, navigation, a visual report, effectivity, options, and revision rules, and in particular can be based on a combination of these.

This step can also include performing a query on a configuration database to retrieve the identified contexts, including corresponding configuration data, and configuring the configuration data. The data can be retrieved from the configuration database. This configuration can then be further refined using the filtering techniques discussed above, including search, navigation, or visual report.

The system displays configuration items corresponding to the identified contexts (step 415). While the configuration items could be displayed in any manner, in particular embodiments, they are each displayed with a thumbnail image and description representing the respective configuration. Since the retrieved contexts have been selected and filtered based on the factors discussed above, of all the available configurations, only the meaningful ones are shown to the user. “Meaningful” is determined based on the users role and group, ownership of the context, creation date, etc., as described above.

The system can receive a user selection of a configuration item (step 420). This can be, for example, a user “clicking” on a configuration item.

The system launches a tool based on the selected configuration item (step 425). This can be a visualization tool or function, a CAD editor, or otherwise. This step can include automatically querying the configuration database to retrieve and configure the configuration data according to the selected configuration item and corresponding identified context.

The system can display a product configuration corresponding to the selected configuration item (step 430), particularly in the case where a visualization tool is launched. The displayed identified configuration can be displayed in a first view as described above, and preferably the first view is defined by the context.

When the system launches the tool and displays the first view, its content can be retrieved “on the fly” and can be different from when it was last loaded. For example, the context may be defined by looking for all parts made of material A. If a new part has been added to the product that is made of material A, then it will be included when the user loads the first view of the product context, even though that part wasn't part of the product configuration the last time that context was loaded.

The system can interact with a user to change the display from the first view to a second view (step 435). This can include performing an on-the-fly configuration to display higher-level or lower-level views (with respect to the first view) of the displayed identified configuration, as described above. The system can change the display to the second view, for example, in response to a user selecting a subassembly of the first view, and the second view can be, for example, a detailed view of that subassembly.

Further, in various embodiments, the steps described herein may be repeated, omitted, performed sequentially or concurrently, performed in a different order, or otherwise, in various implementations within the scope of this disclosure. No component, step, process, or feature should be considered essential to any claim below unless specifically recited in that claim.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “obtain” and its derivatives refer to any acquisition of data or other tangible or intangible item, whether acquired from an external source or internally (such as through internal generation of the item). The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method performed by a product data management (PDM) data processing system, comprising:
determining a user identification;
identifying a plurality of product contexts corresponding to the user identification and based on a user role, including performing a query on a database;
displaying configuration items corresponding to the identified contexts;
receiving a user selection of a configuration item; and
launching a tool based on the selected confirmation item, including loading configuration data according to the selected configuration item and corresponding identified context.

2. The method of claim 1, wherein each product context is defined based on one or more of a user search, navigation, or a visual report.

3. The method of claim 1, wherein the configuration items include thumbnail images and descriptions of the corresponding identified configurations.

4. The method of claim 1, wherein the system also displays the corresponding identified configuration in a first view defined by corresponding identified product context, and thereafter interacts with a user to change the display from a first view to a second view while configuring the second view on the fly.

5. The method of claim 1, wherein each product context is defined based on one or more of effectivity, options, and revision rules.

6. The method of claim 1, wherein the displayed configurations items are determined to be meaningful to a user based on the user role, ownership of the corresponding identified contexts, and creation date.

7. The method of claim 1, wherein the system creates a context according to a user's selected configuration, navigation level, context search, and visual reports, and stores the created context as associated with a configuration item.

8. A product data management (PDM) data processing system, comprising:
a processor;
an accessible memory; and
a display, the PDM data processing system configured to
determine a user identification;
identify a plurality of product contexts corresponding to the user identification and based on a user role, including performing a query on a database;
display configuration items corresponding to the identified contexts;
receive a user selection of a configuration item; and
launch a tool based on the selected confirmation item, including loading configuration data according to the selected configuration item and corresponding identified context.

9. The PDM data processing system of claim 8, wherein each product context is defined based on one or more of a user search, navigation, or a visual report.

10. The PDM data processing system of claim 8, wherein the configuration items include thumbnail images and descriptions of the corresponding identified configurations.

11. The PDM data processing system of claim 8, wherein the system also displays the corresponding identified configuration in a first view defined by corresponding identified product context, and thereafter interacts with a user to change the display from a first view to a second view while configuring the second view on the fly.

12. The PDM data processing system of claim 8, wherein each product context is defined based on one or more of effectivity, options, and revision rules.

13. The PDM data processing system of claim 8, wherein the displayed configurations items are determined to be meaningful to a user based on the user role, ownership of the corresponding identified contexts, and creation date.

14. The PDM data processing system of claim 8, wherein the system creates a context according to a user's selected configuration, navigation level, context search, and visual reports, and stores the created context as associated with a configuration item.

15. A machine-readable medium encoded with machine-executable instructions that, when executed, cause a product data management (PDM) data processing system to:
determine a user identification;
identify a plurality of product contexts corresponding to the user identification and based on a user role, including performing a query on a database;
display configuration items corresponding to the identified contexts;
receive a user selection of a configuration item; and
launch a tool based on the selected confirmation item, including loading configuration data according to the selected configuration item and corresponding identified context.

16. The machine-readable medium of claim 15, wherein each product context is defined based on one or more of a user search, navigation, or a visual report.

17. The machine-readable medium of claim 15, wherein the configuration items include thumbnail images and descriptions of the corresponding identified configurations.

18. The machine-readable medium of claim 15, wherein the system also displays the corresponding identified configuration in a first view defined by corresponding identified product context, and thereafter interacts with a user to change the display from a first view to a second view while configuring the second view on the fly.

19. The machine-readable medium of claim 15, wherein each product context is defined based on one or more of effectivity, options, and revision rules.

20. The machine-readable medium of claim 15, wherein the displayed configurations items are determined to be meaningful to a user based on the user role, ownership of the corresponding identified contexts, and creation date.
